(19) United States
(12) Patent Application Publication
(10) Pub. No.: US 2006/0033819 A1
(43) Pub. Date: Feb. 16, 2006

(54) Method and apparatus for automatic orientation correction of digital photographs

(75) Inventors: Arthur H. Ozaki, Escondido, CA (US); Peter Shintani, San Diego, CA (US)

Correspondence Address: FITCH EVEN TABIN & FLANNERY, 120 SOUTH LASALLE SUITE 1600, CHICAGO, IL, 60603, US

(73) Assignees: Sony Corporation, Shinagawa-Ku (JP); Sony Electronics Inc., Park Ridge, NJ (US)

(21) Appl. No.: 10/918,172

(22) Filed: Aug. 12, 2004

(51) Int. Cl. H04N 5/228

(52) U.S. Cl. 348/208.99

(57) ABSTRACT

Disclosed is a method and apparatus for automatic orientation correction of images stored within a digital camera. The digital camera described herein comprises an orientation selector that allows the user to select among various image orientations, such as a landscape style orientation and a portrait style orientation. In one embodiment, software resident on the digital camera responds to actuation of the orientation selector by automatically rotating the image upright and storing the rotated image in the digital camera. In another embodiment, recordable image space of the digital camera is adjusted such that the recordable image space has dimensions equal to the dimensions of the image orientation selected. In a still further embodiment, software resident on the digital camera crops the image such that the image has dimensions equal to the dimensions of the image orientation selected.

### BACKGROUND OF THE INVENTION

1. Field of the Invention

The present invention relates generally to digital cameras. More specifically, the present invention relates to a system and method for automatic orientation correction of digital photographs.

2. Discussion of the Related Art

Digital cameras are cameras with an electronic sensor that record images as electronic data rather than as chemical changes on photographic film. The sensor in a digital camera is usually a light sensitive charge-coupled device (CCD) or a complementary metal-oxide semiconductor (CMOS). A digital memory device (for example, flash memory, read-only memory, or removable memory) is usually used for storing the recorded images. After the picture is stored on the camera, the picture can be displayed on the digital camera's display screen. Optionally, the picture may be transferred to a remote computer for storage on a hard drive and subsequently viewed on the remote computer's display screen.

The orientation of a picture taken by a digital camera depends on how the digital camera was held when the picture was taken. When taking a landscape style picture, the digital camera is held in a horizontal or normal orientation when the picture is taken. When taking a portrait style picture, the digital camera is in a vertical orientation (i.e., the camera is rotated ninety degrees clockwise or counterclockwise from the camera's normal position). Digital cameras cannot recognize that the camera was rotated when the picture was taken. For this reason, portrait style pictures will appear sideways when viewed.

Similarly, when the pictures stored on the camera are later transferred to a computer, the pictures taken in a landscape orientation will display upright on the computer screen, but the pictures taken in a portrait orientation will be rotated ninety degrees from the camera's normal orientation. In order to view the portrait style pictures with the correct orientation, the user must either tilt their head sideways or use an image editor or image software to rotate the picture ninety degrees upright.

### SUMMARY OF THE INVENTION

The present invention solves the above and other problems by providing a system and method for orientation correction of digital photographs.

In one embodiment, the invention can be characterized as a camera comprising a sensor that detects light and records an image comprising image data, a controller that controls the processing of the image within the camera, and an orientation selector that selects among image orientations for the image.

In another embodiment, the invention can be characterized as a method comprising the steps of determining a desired image orientation, adjusting a recordable image space on a digital camera to dimensions of the desired image orientation, and recording an image in the recordable image space.

In a further embodiment, the invention may be characterized as a method comprising the steps of determining a desired image orientation, recording an image with a digital camera, and rotating the image based upon the desired image orientation.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a block diagram illustrating a hardware configuration of a digital camera in accordance with one embodiment;

FIG. 2 is a diagram illustrating automatic orientation correction of a stored image by a digital camera in accordance with one embodiment;

FIG. 3 is a diagram illustrating a landscape style image area in accordance with one embodiment;

FIG. 4 is a diagram illustrating a modified recordable image space with portrait style dimensions in accordance with one embodiment;

FIG. 5 is a diagram illustrating a cropped landscape style picture with portrait style dimensions;

FIG. 6 is a flow diagram illustrating a method of adjusting a recordable image space on a digital camera in order to record an image with a desired image orientation; and

FIG. 7 is a flow diagram illustrating a method of rotating an image on a digital camera in order to record the image with a desired image orientation.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims.

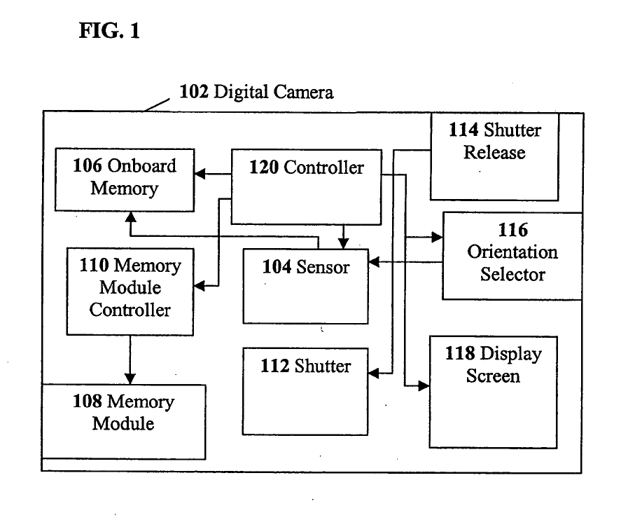

Referring to FIG. 1, a block diagram is shown illustrating a hardware configuration of a digital camera in accordance with one embodiment. Shown is the digital camera 102, a sensor 104, an onboard memory 106, a memory module 108, a memory module controller 110, a shutter 112, a shutter release 114, an orientation selector 116, a display screen 118, and a controller 120.

The shutter release 114 is electronically coupled to the shutter 112. The memory module 108 is electronically coupled to the memory module controller 110. The sensor 104 is electronically coupled to the orientation selector 116 and the onboard memory 106. The controller is electronically coupled to the onboard memory 106, the memory module controller 110, the sensor 104, the orientation selector 116, and the display screen 118.

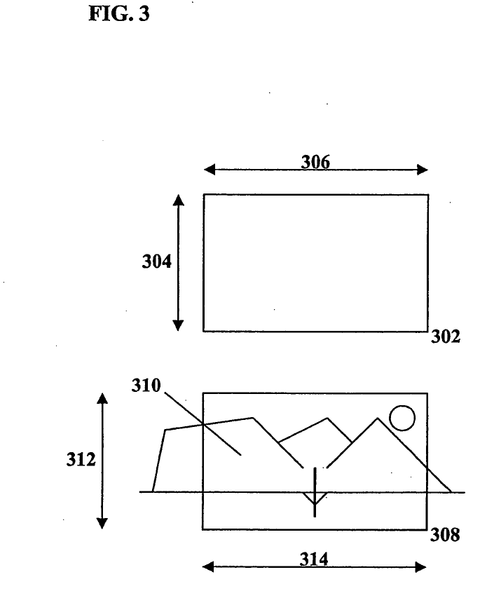

In operation, a user of the digital camera 102 activates the shutter release 114, which opens the shutter 112 and exposes the sensor 104 to light. The sensor 104 records image data corresponding to an amount of light that the sensor detects while the shutter 112 remains open. An amount of image data that the sensor is able to record defines a recordable image space on the digital camera 102. For example, FIG. 3 shows a recordable image space 302 of the digital camera 102. A height 304 and a width 306 functionally determine the area of the recordable image space 302.

The image data recorded by the sensor 104 is stored in the onboard memory 106 of the digital camera 102 and optionally stored on the memory module 108. The memory module 108 is typically a non-volatile memory device (such as flash memory) that interfaces with the controller 120 through the memory module controller 110. The onboard memory 106 is typically a volatile memory device (such as random access memory) providing the controller 120 with direct access to data stored within.

The controller 120 controls the central processing and storage of data within the digital camera 102. The controller 120 is typically a microprocessor or microcontroller. Many different controllers that are well known in the art can be utilized. The controller executes low-level instructions in accordance with an instruction set that the controller 120 recognizes. In essence, the controller functions as the brain of the digital camera 102, performing commands in the digital camera 102 after the commands have been broken down into to a series of low-level instructions.

The display screen 118 performs a variety of functions. First, the display screen 118 acts as a viewfinder, allowing the user of the digital camera 102 to digitally view a target subject immediately before taking a picture. The display screen 118 also displays recorded images or video stored on the onboard memory 106 and the memory module 108. Additionally, the display screen allows for electronic viewing and adjustment of various settings in the digital camera 102.

The orientation selector 116 selects among image orientations on the digital camera 102. One embodiment includes a landscape style orientation and a portrait style orientation as the image orientations. Other embodiments include additional image orientations as well.

The orientation selector 116 is implemented in a variety of ways. In some embodiments, the orientation selector 116 is implemented mechanically, for example, by a switch, lever, or button physically present on the digital camera 102 (for example, an alternative shutter release button). In other embodiments, the orientation selector 116 is implemented electronically via a user interface accessible through a menu that displays on the display screen 118. As discussed below, various embodiments respond differently to actuation of the orientation selector 116. Still in further embodiments, the camera itself will determine the orientation of the camera. For example, the camera can be equipped with a ball that detects the orientation of the camera and automatically changes the image orientation. Still alternatively, an IR detection mechanism can be used to set the image orientation.

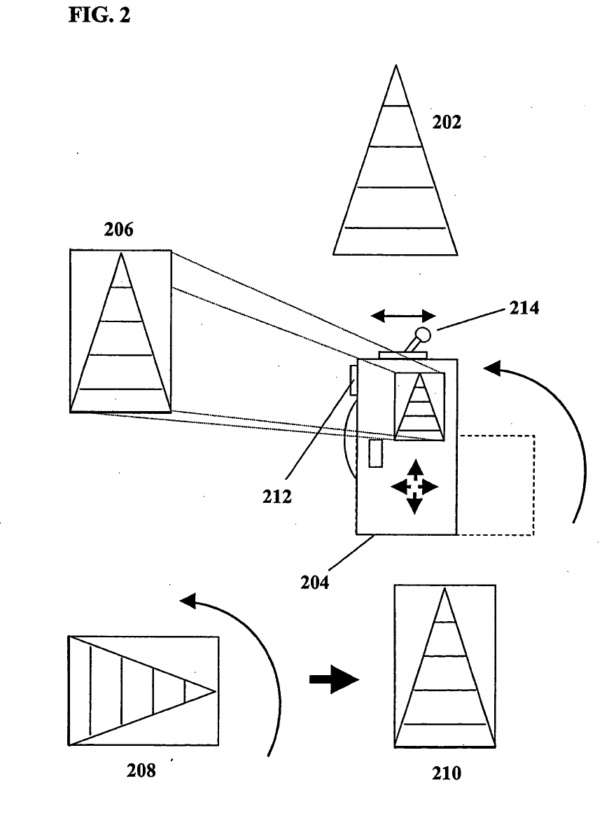

FIG. 2 is a diagram illustrating automatic orientation correction of a stored image by a digital camera 204 in accordance with one embodiment. Shown is a target subject 202, a digital camera 204, a shutter release 212, a display screen 206, a first image 208, and a resulting image 210.

First, a user physically rotates the digital camera 204 ninety degrees in order to view the target subject 202 in portrait style dimensions. The display screen 206 of the digital camera 204 displays the target subject 202 to be recorded. Next, the user selects the portrait style orientation with the orientation selector 214. The orientation selector 214 is implemented by means of a physical switch that the user toggles in order to select among image orientations. After the user presses the shutter release 212, the shutter opens, and the first image 208 is recorded and stored to the onboard memory 106 (i.e., a picture is taken). The first image 208 is recorded in a sideways orientation. After the first image 208 is stored to the onboard memory 106, the controller 120 in conjunction with software resident in the digital camera 204 rotates the first image 208 such that the first image 208 has an upright orientation, thus creating the resulting image 210. The resulting image 210 is then stored in the memory module 108.

Advantageously, the resulting image 210 displays upright independent of the capabilities of display software resident on a displaying computer. Previously, in order to ensure that an image was displayed upright during a presentation, a digital camera typically utilized an orientation sensor. The orientation sensor was, for example, a pendulum or a ball that moved to different locations inside the camera when the camera was rotated. The digital camera wrote flags to the image indicating the orientation of the digital camera when the picture was taken. For example, a flag might be a signed decimal number such as +90. This number represented the number of degrees that the camera was rotated in a counterclockwise direction relative to horizontal.

In order to be able to display the image upright, display software had to be able to read the flags written inside the image. In some cases, the flags were stored in formats or bit locations inside of the image that the display software could not recognize or interpret. In other cases, the display software lacked the ability to rotate the image. For these reasons, portrait style pictures often displayed sideways during a presentation, unless the user first manually rotated the pictures upright with an image editor. However, in accordance with the embodiment mentioned herein, rotation of the first image 208 occurs within the digital camera 204 itself, thus obviating the need for storing and reading the flags, or for rotating a portrait style picture with display software or an image editor.

In another embodiment, the digital camera 204 functionally sets the dimensions of the viewable image (alternatively, the dimensions of the recordable image space 302) according to which image orientation has been selected by the orientation selector 214. In such cases, the digital camera advantageously does not need to be rotated ninety degrees in order to take a picture with portrait style dimensions. Furthermore, stored portrait style pictures do not require the displaying software to rotate the picture to ensure that the picture displays upright. This process is described below herein with reference to FIG. 3-FIG. 5.

FIG. 3 illustrates a landscape style image area 308 in accordance with one embodiment. Shown are a recordable image space 302 with a recordable image space height 304 and a recordable image space width 306, the landscape style image area 308 with a landscape style image area height 312 and a landscape style image area width 314, and the target subject 310 to be recorded.

The landscape style image area 308 has dimensions such that the landscape style image area height 312 is proportionately smaller than the landscape style image area width 314 (for example, a 4×6 ratio). Both the landscape style image area height 312 and the landscape style image area width 314 comprise the landscape style image area 308. As shown in FIG. 3, the portion of the target subject 310 that falls within the landscape style image area 308 corresponds what is actually represented by the image recorded by the digital camera 102.

When the digital camera 102 has the landscape style orientation selected, the recordable image space height 304 and the recordable image. space width 306 are set to be equal to the dimensions of the landscape style image area 308. As shown, the landscape style image area has the same dimensions as the recordable image space 302, thus maximizing sensor use in the digital camera 102. Alternatively, the landscape style image area 308 occupies a portion of the recordable image space 302 of the digital camera 102. When the digital camera 102 has the landscape style orientation selected, the image that is recorded and stored to the onboard memory 106 has dimensions equal to or proportionate to the landscape style image area.

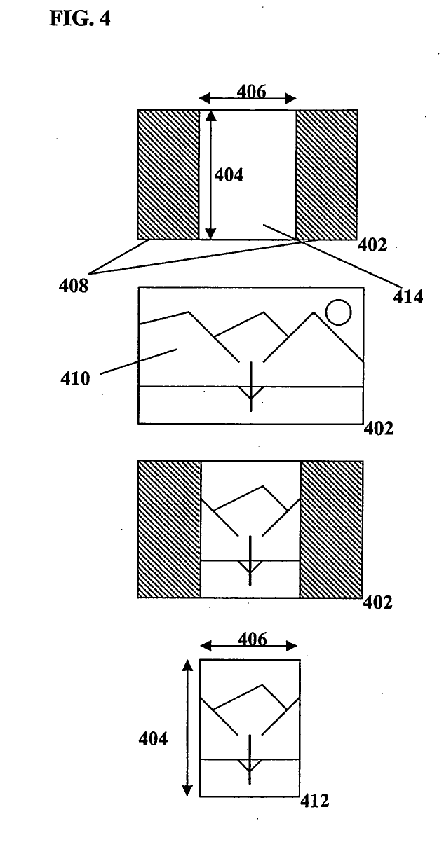

FIG. 4 is a diagram illustrating a modified recordable image space 414 with portrait style dimensions in accordance with one embodiment. Shown is an unmodified recordable image space 402, sides 408 of the unmodified recordable image space 408, a modified recordable image space 414, a modified recordable image space height 404, a modified recordable image space width 106, a target subject 410, and a resulting image 412.

When the digital camera 102 has the portrait style orientation selected, a portion of the recordable image space 402 is unused (i.e., the sides 408 of the recordable image space), yielding the modified recordable image space 414 with a modified recordable image space height 404 and a modified recordable image space width 406 of portrait style dimensions. In a preferred embodiment, the sides 408 of the recordable image space 402 correspond to the portion of the recordable image space 402 that is unused, yielding the modified recordable image space 414 in the center of the recordable image space 402. In other embodiments, the modified recordable image space 414 is shifted relative to the center of the recordable image space 402 (for example, the modified recordable image space 414 is located on the right or left side of the recordable image space 402).

When a picture is taken of the target subject 410, the resulting image 412 is recorded by the sensor 104 and stored to the onboard memory 106. Advantageously, the user is not required to rotate the digital camera 102 in order to achieve a recordable image space 302 with portrait style dimensions. Furthermore, since the resulting image 412 is stored with an upright orientation, no further image rotation or post-processing is necessary to ensure that the resulting image 412 is displayed upright.

Modifying the recordable image space 402 in order to produce the modified recordable image space 414 is implemented in a variety of ways. For example, in one embodiment, a portion of the sensor responsible for storing the image data corresponding to the sides 408 of the recordable image space 402 is shut off or deactivated when the digital camera 102 has the portrait style orientation selected. This is accomplished by software resident on the digital camera 102 driving the sensor 104. Alternatively, this is accomplished mechanically by means of a physical switch or other triggering mechanism present in the digital camera 102 that controls the state of the sensor (i.e., determines what portion of the sensor is on or off).

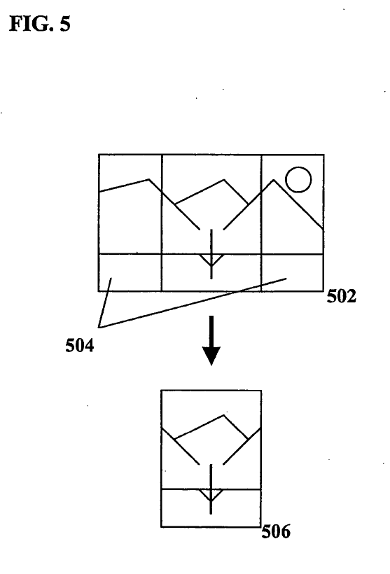

FIG. 5 is a diagram illustrating a cropped landscape style picture with portrait style dimensions. Shown are a landscape style picture 502, sides of the landscape style picture 504, and a cropped picture 506 with portrait style dimensions.

In one embodiment, when the digital camera 102 has the portrait style orientation selected, the entire recordable image space 302 stores the image data as the landscape style picture 502. Software resident on the digital camera 102 crops off the sides 504 the landscape style picture 502, yielding the cropped picture 506 with portrait style dimensions. Alternatively, different regions of the landscape style picture are cropped to yield the cropped picture 506. While this may result in a portrait style picture of a less number of pixels a compared to the landscape style picture, many digital cameras today have a much higher pixel capability than a typical user needs. Thus, even when the picture is cropped, the typical users will notice no decrease in picture quality.

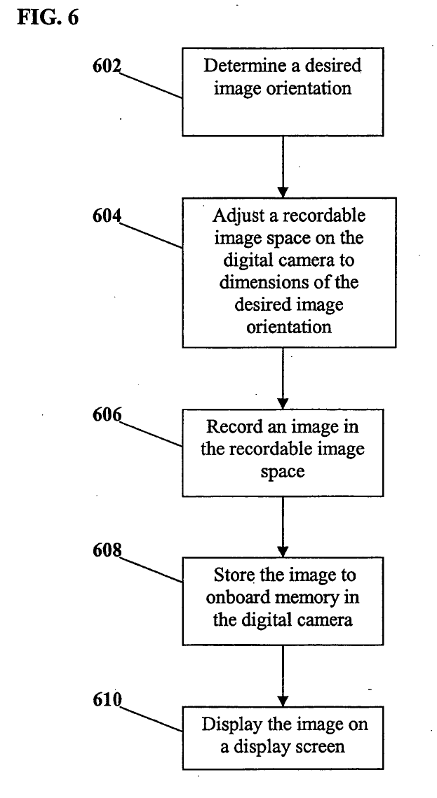

FIG. 6 is a flow diagram illustrating a method of adjusting a recordable image space on a digital camera in order to record an image with a desired image orientation.

In step 602, a desired image orientation is determined. In a preferred embodiment, this is accomplished by user input to an orientation selector that selects among image orientations on the digital camera. In step 604, the recordable image space on the digital camera is adjusted such that the recordable image space has dimensions equal to or proportionate to the desired image orientation. In one embodiment, this is accomplished by deactivating a portion of the sensor such that an active portion of the sensor has a recordable image space with dimensions equal to or proportionate to the desired image orientation. In another embodiment, software resident on the digital camera reads a portion of the recordable image space on the digital camera, where said portion has dimensions equal to or proportionate to the desired image orientation. In this manner, the entire sensor is still active, however, the camera ignores part of the sensor space. In step 606, the image is recorded in the recordable image space of the digital camera (i.e. a picture is taken). In step 608, the image is stored to onboard memory in the digital camera. The picture will be stored with portrait style picture dimensions without the need for a user to rotate the camera and then later edit the picture with the user of software on a computer. In step 610, the image is displayed on the display screen of the digital camera.

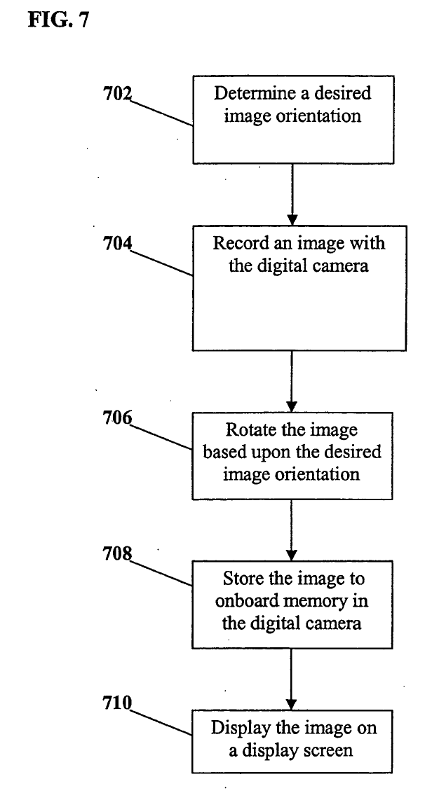

FIG. 7 is a flow diagram illustrating a method of rotating an image on a digital camera in order to record the image with a desired image orientation.

In step 702, a desired image orientation is determined. For example, a user will select between a portrait and landscape style picture. In a preferred embodiment, this is accomplished by user input to an orientation selector that selects among image orientations on the digital camera. In step 704, the image is recorded by the digital camera (i.e. a picture is taken). In step 706, the image is rotated based on the desired image orientation. In a preferred embodiment, software resident on the digital camera rotates the image if the digital camera has a portrait style orientation selected. Thus, when a user has rotated the camera ninety degrees in order to take a portrait style picture, the camera will automatically, rotate the image ninety degrees such that it is stored as a portrait style picture. In step 708, the image is stored to onboard memory in the digital camera. In step 710, the image is displayed on the display screen of the digital camera.

The embodiments described herein with reference to FIGS. 1-7 have been described in terms of taking a digital photograph. It should be understood that this also includes taking a video recording with a digital camera or a video recorder.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A camera comprising:
a sensor that detects light and records an image comprising image data;
a controller that controls the processing of the image within the camera; and
an orientation selector that selects among image orientations for the image.

2. The camera of claim 1 wherein the image orientations comprise a landscape style orientation and a portrait style orientation; wherein the landscape style orientation has landscape style dimensions comprising a landscape width and a landscape height such that the landscape width is proportionally greater than the landscape height; and wherein the portrait style orientation has portrait style dimensions comprising a portrait width and a portrait height such that the portrait height is proportionally greater than the portrait width.

3. The camera of claim 2 further comprising software, wherein actuation of the orientation selector to a first image orientation causes the software to rotate the image, thus creating a rotated image.

4. The camera of claim 3 wherein the first image orientation is the portrait style orientation.

5. The camera of claim 2 further comprising an area switch that controls dimensions of an area recordable by the sensor, wherein the image has dimensions equal to the dimensions of the area recordable by the sensor; and wherein actuation of the orientation selector toggles the area switch.

6. The camera of claim 5 wherein actuation of the orientation selector to the portrait style orientation toggles the area switch to generate the portrait style dimensions for the area recordable by the sensor.

7. The camera of claim 5 wherein actuation of the orientation selector to the landscape style orientation toggles the area switch to generate the landscape style dimensions for the area recordable by the sensor.

8. The camera of claim 2 wherein actuation of the orientation selector sets dimensions of an area recordable by the sensor.

9. The camera of claim 8 wherein actuation of the orientation selector to the portrait style orientation sets the area recordable by the sensor to have portrait style dimensions.

10. The camera of claim 8 wherein actuation of the orientation selector to the landscape style orientation sets the area recordable by the sensor to have landscape style dimensions.

11. A method comprising the steps of:
determining a desired image orientation;
adjusting a recordable image space on a digital camera to dimensions of the desired image orientation; and
recording an image in the recordable image space.

12. The method of claim 11 wherein the desired image orientation is a portrait style orientation.

13. The method of claim 11 wherein the desired image orientation is a landscape style orientation.

14. The method of claim 11 further comprising the step of storing the image to onboard memory within the digital camera.

15. The method of claim 11 further comprising the step of displaying the image on a display screen.

16. A method comprising the steps of:
determining a desired image orientation;
recording an image with a digital camera; and
rotating the image based upon the desired image orientation.

17. The method of claim 16 wherein the desired image orientation is a portrait style orientation.

18. The method of claim 16 wherein the desired image orientation is a landscape style orientation.

19. The method of claim 16 further comprising the step of storing the image to onboard memory within the digital camera.

20. The method of claim 16 further comprising the step of displaying the image on a display screen.
